(19) United States
(12) Patent Application Publication
(10) Pub. No.: US 2024/0387132 A1
(43) Pub. Date: Nov. 21, 2024

(54) RELAY

(71) Applicant: Xiamen Hongfa Electric Power Controls Co., Ltd, Xiamen (CN)

(72) Inventors: Wenguang Dai, Xiamen (CN); Zengguang Zheng, Xiamen (CN); Fangneng Li, Xiamen (CN); Shuming Zhong, Xiamen (CN)

(21) Appl. No.: 18/664,422

(22) Filed: May 15, 2024

(30) Foreign Application Priority Data
May 18, 2023 (CN) 2023105651722
May 18, 2023 (CN) 2023212185427

(51) Int. Cl. H01H 50/54; H01H 50/18

(52) U.S. Cl. CPC H01H 50/54; H01H 50/18

(57) ABSTRACT

A relay includes a base having a first contact area, a second contact area and a middle area between the first contact area and the second contact area; a pair of contact parts respectively arranged in the first contact area and the second contact area; each contact part including two sets of the movable contact part, each set of the movable contact part including a movable contact piece with a movable contact and a static contact on both ends, two movable contacts corresponding to two static contacts respectively in each contact part; and a magnetic circuit part on the middle area of the base for drive four movable contact pieces of the pair of contact parts through a push rod assembly to move, thereby realizing connection or disconnection of the movable contact and the static contact.

### CROSS REFERENCE

This application is based upon and claims priority to Chinese Patent Application No. 202310565172.2 and 202321218542.7, both filed on May 18, 2023, the entire contents thereof are incorporated herein by reference.

### TECHNICAL FIELD

The present disclosure relates to the field of electronic control device technology, specifically to a relay.

### BACKGROUND

A relay is an electronic control device that has a control system (also known as an input circuit) and a controlled system (also known as an output circuit), and is typically used in automatic control circuits. Essentially, the relay is an “automatic switch” that uses a smaller current to control a larger current. Therefore, it plays roles such as automatic regulation, safety protection, and circuit switching in electrical circuits.

With the continuous expansion of the application scope of the relay, the relay is also developing in the direction of high load and miniaturization. However, the temperature rise problem of the relay in the prior art has not been well solved, is prone to the accelerated aging of plastics and insulating materials inside the relay, the difficulty of arc extinguishing due to oxidation corrosion of contacts, the decay of technical parameters of electrical components, and the reduction of reliability.

### SUMMARY

In one aspect of present disclosure, a relay, including:
a base having a middle area, a first contact area and a second contact area, the middle area is arranged between the first contact area and the second contact area, the first contact area and the second contact area are arranged spaced with each other along the first direction;
a pair of contact parts respectively arranged in the first contact area and the second contact area; each contact part including two sets of the movable contact part, each set of the movable contact part including a movable contact piece, a movable contact and a static contact, the movable contact piece having a first end and a second end in a second direction, the movable contact being provided on the first end and the static contact being provided on the second end; two movable contacts corresponding to two static contacts respectively in each contact part; wherein the second direction is perpendicular to the first direction; and
a magnetic circuit part arranged on the middle area of the base, and configured to drive four movable contact pieces of the pair of contact parts through a push rod assembly to move, thereby realizing connection or disconnection of the movable contact and the static contact.

According to some embodiments of the present disclosure, wherein each set of movable contact part further includes a movable contact leading-out piece connected to the movable contact piece.

According to some embodiments of the present disclosure, wherein four movable contact leading-out pieces in a pair of contact part are located at four corners of the base respectively.

According to some embodiments of the present disclosure, wherein in each set of the movable contact part, the static contact is located at a connection position of the second end and the movable contact leading-out piece of the movable contact piece.

According to some embodiments of the present disclosure, wherein a length of the movable contact piece extends along the second direction.

According to some embodiments of the present disclosure, wherein the base includes:
a first partition, arranged between the first contact area and the middle area;
a second partition, arranged between the second contact area and the middle area.

According to some embodiments of the present disclosure, wherein the base further has a first moving area and a second moving area spaced from each other along the second direction, and the middle area is located between the first moving area and the second moving area;
the push rod assembly includes a first push rod and a second push rod, the magnetic circuit part respectively drivably connected to the first push rod and the second push rod, so that the first push rod movably arranged in the first moving area, and the second push rod movably arranged in the second moving area;
one end of the first push rod is connected to the first end of one of the movable contact pieces of the contact part in the first contact area, the other end of the first push rod is connected to the first end of one of the movable contact pieces of the contact part in the second contact area;
one end of the second push rod is connected to the first end of one of the other movable contact pieces of the contact part in the first contact area, the other end of the second push rod is connected to the first end of the other movable contact piece of the contact part in the second contact area.

According to some embodiments of the present disclosure, wherein the magnetic circuit part includes a coil assembly and an armature assembly, the armature assembly is pivotally connected to the base under a magnetic driving action of the coil assembly;
the armature assembly is respectively connected to the first push rod and the second push rod and configured to drive the first push rod and the second push rod to reciprocate in the first direction.

According to some embodiments of the present disclosure, wherein the first push rod and the second push rod move in opposite directions.

According to some embodiments of the present disclosure, wherein the first contact area, the first moving area, the second contact area and the second moving area are sequentially connected end-to-end to form a rectangular structure.

According to some embodiments of the present disclosure0, wherein in a pair of contact part, four sets of the movable contact and the static contact are located at four corners of the rectangular structure respectively.

According to some embodiments of the present disclosure, wherein each set of the movable contact part further includes a movable contact leading-out piece connected to the movable contact piece, the static contact is arranged on the movable contact piece and/or the movable contact leading-out piece;
four movable contact leading-out pieces in a pair of contact part are located at four corners of the rectangular structure respectively.

According to some embodiments of the present disclosure, wherein the base further includes:
a third partition, arranged between the first moving area and the middle area;
a fourth partition, arranged between the second moving area and the middle area.

According to some embodiments of the present disclosure, wherein the movable contact piece includes a plurality of sub-contact pieces stacked with each other.

According to some embodiments of the present disclosure, wherein two movable contact pieces in the contact part are parallel with each other, and the two movable contact pieces have inner surfaces facing each other.

According to some embodiments of the present disclosure, wherein a length direction and the second direction of the movable contact piece are parallel with each other;
opposite ends of the movable contact piece in the length direction are respectively provided with the first end and the second end.

### BRIEF DESCRIPTION OF THE DRAWINGS

FIG. 1 illustrates a top schematic view of a relay according to an embodiment of the present disclosure, with the upper cover omitted.

FIG. 2 shows a three-dimensional view of a base in FIG. 1.

FIG. 3 shows a schematic view of the relay of FIG. 1 with the base omitted.

FIG. 4 shows a cross-sectional view of the magnetic circuit part.

FIG. 5 is a three-dimensional view of the movable contact part.

FIG. 6 illustrates a top schematic view of a relay according to an embodiment of the present disclosure, with the upper cover omitted.

FIG. 7 shows a schematic view of the relay of FIG. 6 with the base omitted, and the contact part in a disconnected state.

FIG. 8 shows a cross-sectional view of the magnetic circuit part.

FIG. 9 shows a three-dimensional schematic view of the contact part according to a first embodiment of the present disclosure.

FIG. 10 shows a top schematic view of one of the movable contact parts in the contact part according to the first embodiment of the present disclosure.

FIG. 11 shows an exploded schematic view of one of the movable contact parts in the contact part according to the first embodiment of the present disclosure, where the movable contact piece is not provided with a slit.

FIG. 12 shows a three-dimensional schematic view of the contact part according to a second embodiment of the present disclosure.

FIG. 13 shows a top schematic view of one of the movable contact parts in the contact part according to the second embodiment of the present disclosure.

FIG. 14 shows an exploded schematic view of one of the movable contact parts in the contact part according to the second embodiment of the present disclosure, where the movable contact piece is provided with a slit.

FIG. 15 shows a top schematic view of one of the movable contact parts in the contact part according to a third embodiment of the present disclosure.

FIG. 16 shows a top schematic view of one of the movable contact parts in the contact part according to a fourth embodiment of the present disclosure.
10: base
101: bottom plate
102: side wall
110: middle area
120: first contact area
130: second contact area
140: first moving area
150: second moving area
161: first partition
162: second partition
163: third partition
164: fourth partition
20: contact part
20a: movable contact part
210: movable contact piece
211: sub-contact piece
212: current carrier
213: end face
214: slit
2120: inner surface
210a: first end
210b: second end
220: movable contact unit
221: movable contact
230: static contact unit
231: static contact
240: movable contact leading-out piece
250: first contact
260: second contact
30: magnetic circuit part
310: coil assembly
320: armature assembly
321: permanent magnet
322: armature
323: swinging arm
40: push rod assembly
410: first push rod
420: second push rod
D1: first direction
D2: second direction
D3: length direction
D4: width direction

### DETAILED DESCRIPTION

Example embodiments will now be described more fully with reference to the accompanying drawings. Example embodiments may, however, be embodied in various forms and should not be construed as limited to the embodiments set of forth herein; rather, these embodiments are provided so that this disclosure will be thorough and complete, and will fully convey the concepts of the example embodiments. To those skilled in the art. The same reference numerals in the drawings indicate the same or similar structures, and thus their detailed descriptions will be omitted.

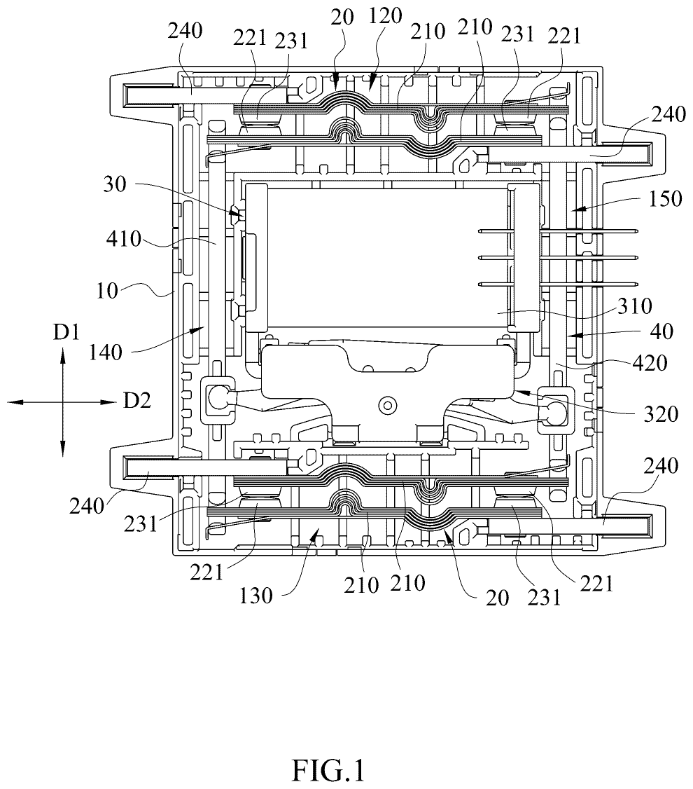

As shown in FIGS. 1 to 3, a relay according to the embodiments of the present disclosure includes a base 10, a pair of contact parts 20, a magnetic circuit part 30, and a push rod assembly 40. The pair of contact parts 20 and the magnetic circuit part 30 are disposed on the base 10 The magnetic circuit part 30 drives contacts of the pair of contact parts 20 to connect or disconnect through the push rod assembly 40.

It is understood that the terms “include” and “have” and their any variations used in the embodiments of the present disclosure are intended to cover non-exclusive inclusions. For example, a process, method, system, product, or apparatus that includes a series of steps or units is not limited to the listed steps or units, but may optionally include steps or units not listed, or may optionally include other inherent steps or components for these processes, methods, products, or apparatuses.

The base 10 may include a bottom plate 101 and the side wall 102 connected to the periphery of the bottom plate 101. The side wall 102 and the bottom plate 101 enclose a chamber for accommodating the pair of contact part 20, the magnetic circuit part 30 and the push rod assembly 40.

In one embodiment, the base 10 may be substantially cubic in shape, but is not limited thereto.

The base 10 has a middle area 110, a first contact area 120 and a second contact area 130. The middle area 110 is arranged between the first contact area 120 and the second contact area 130, and the first contact area 120 and the second contact area 130 are arranged spaced from each other along the first direction D1.

A pair of contact parts 20 may be respectively disposed inside the first contact area 120 and the second contact area 130.

Each contact part 20 includes two sets of movable contact parts 20a. Each set of movable contact parts 20a includes a movable contact piece 210, a movable contact 221, and a static contact 231. The movable contact piece 210 has a first end 210a and a second end 210b disposed oppositely in the second direction D2. The movable contact 221 is disposed on the first end 210a, and the static contact 231 is disposed on the second end 210b. The two movable contact units 220 of each contact part 20 correspond to the two static contact units 230 respectively. Where the second direction D2 is perpendicular to the first direction D1.

The length direction of the movable contact piece 210 is parallel with the second direction D2. The first end 210a and the second end 210b are respectively arranged at the opposite ends of the length direction of the movable contact piece 210. In this way, the distance between the movable contact 221 and the static contact 231 can be as large as possible, The thermal radiation generated by one set of the movable contact 221 and the static contact 231 is prevented from influencing the other set of the movable contact 221 and the static contact 231, and the temperature rise of the contact part 20 is effectively reduced.

The magnetic circuit part 30 is disposed on the middle area 110 of the base 10 and is used to drive the movement of four movable contact pieces 210 of the pair of contact parts 20 through the push rod assembly 40, thereby connecting and disconnecting the movable contact units 220 and the static contact units 230.

It is understood that the relay of the embodiments of the present disclosure includes a pair of contact parts 20. Each contact part 20 can control one circuit, so that the relay of the embodiments of the present disclosure can control at least two circuits. Two contact parts 20 are arranged on the base 10 spaced with each other in the first direction D1.

Wherein each contact part 20 includes two sets of movable contact parts 20a, and the structural design of the movable contact parts 20a are basically the same. Two sets of movable contact parts 20a are approximately parallel with each other, and each includes a movable contact piece 210, a movable contact 221 and a static contact 231.

Further, two movable contact pieces 210 in each contact part 20 are parallel with each other, and the two movable contact pieces 210 respectively have an inner surface 2120 facing each other. When the contact part 20 is closed, a parallel loop is formed. The two movable contact piece 210 have the same current direction. In the case of short circuit, the opposing inner surfaces 2120 in the contact part 20 are magnetically attracted with each other, which can resist the electric repulsion force, so as to maintain the movable contact 221 and the static contact 231 in a closed state.

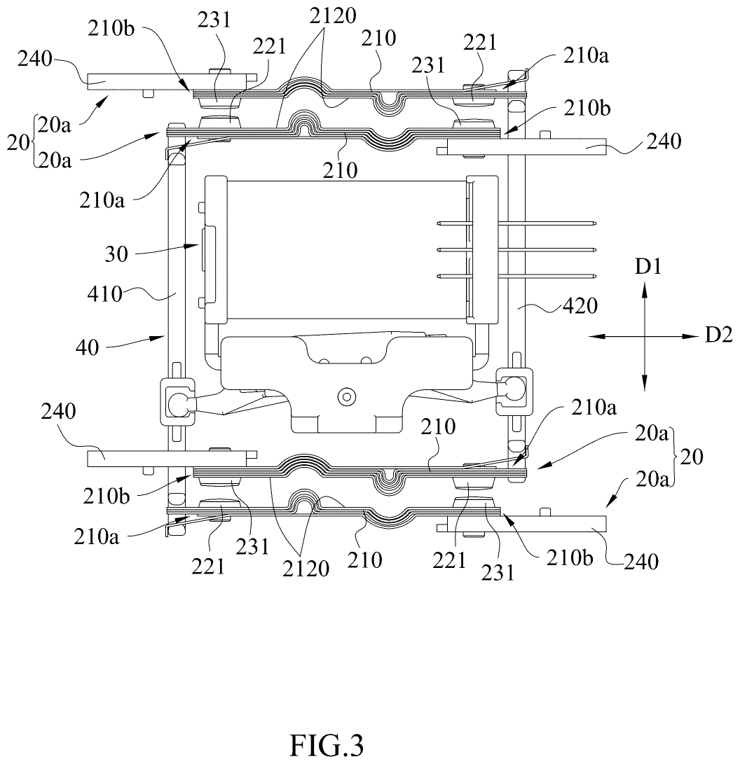

Two sets of movable contact part 20a are arranged oppositely in the second direction D2. Specifically, as shown in FIGS. 1 and 3, the contact part 20 located in the first contact area 120 will be taken as an example for explanation. Two movable contact pieces 210 in two sets of movable contact part 20a are approximately parallel. The first end 210a of one of the movable contact pieces 210 corresponds to the second end 210b of the other movable contact piece 210, the second end 210b of one of the movable contact pieces 210 corresponds to the first end 210a of the other movable contact piece 210. Since the movable contact 221 is disposed on the first end 210a of the movable contact piece 210, and the static contact 231 is disposed on the second end 210b of the movable contact piece 210. Thus, the movable contact 221 in one set of movable contact part 20a corresponds to the static contact 231 in the other set of movable contact part 20a, and the static contact 231 of one set of movable contact part 20a corresponds to the movable contact 221 of the other set of movable contact part 20a. Therefore, when the magnetic circuit part 30 drives the movable contact piece 210 to move through the push rod assembly 40, two pair movable contact units 220 and static contact units 230 in one set of movable contact part 20a contact to form a circuit structure in parallel.

It is understood that, during the action of the relay, the movable contact piece 210 is both an action part and a current carrier, therefore, the movable contact piece 210 is a part that is easy to generate temperature rise in the relay.

In the relay of the embodiment of the present invention, two contact parts 20 are spaced from each other on the first direction D1, and in each contact part 20, two sets of movable contact 221 and the static contact 231 are spaced from each other on the second direction D2. On the whole, two contact parts 20 are located in the first contact area 120 and the second contact area 130 of the base 10, respectively, and separated by the magnetic circuit part 30 located in the middle area 110 of the base 10, therefore, the influence of thermal radiation generated by one contact part 20 on the other contact part 20 is effectively reduced. As for the contact part 20 separately, two sets of movable contact 221 and the static contact 231 in each contact part 20 are spaced from each other along the second direction D2. Since the movable contact 221 is located at the first end 210a of the movable contact piece 210, the static contact 231 is located at the second end 210b of the movable contact piece 210, so on the second direction D2, the distance between two sets of movable contact 221 and the static contact 231 in each contact part 20 is also as large as possible. The influence of heat radiation generated by one of the sets of movable contact 221 and the static contact 231 on the other set of movable contact 221 and the static contact 231 is reduced. To sum up, by arranging two contact part 20 spaced from each other in the first direction D1, The structural design of two sets of movable contact 221 and the static contact 231 in each contact part 20 on the second direction D2 effectively reduces the temperature rise of the whole relay and improves the reliability and service life of the relay.

With continued reference to FIGS. 1 to 3, each set of movable contact part 20a further includes a movable contact leading-out piece 240 connected to the movable contact piece 210. In each set of movable contact part 20a, the static contact 231 is located at the connection position of the second end 210b of the movable contact piece 210 and the movable contact leading-out piece 240.

The length of the movable contact piece 210 extends along the second direction D2, thus the first end 210a and the second end 210b of the movable contact piece 210 are disposed oppositely on the length direction of the movable contact piece 21. Therefore, the distance between the movable contact 221 and the static contact 231 arranged on the movable contact piece 210 can be as large as possible, and the influence of heat radiation between two sets of movable contact 221 and the static contact 231 can be reduced.

As shown in FIG. 1, four movable contact leading-out pieces 240 in a pair of contact part 20 are located at four corners of the base 10. In this way, the distance between the four movable contact leading-out pieces 240 can be as large as possible, and the problem that the four movable contact leading-out pieces 240 are centrally arranged can be avoided. At the same time, four movable contact leading-out pieces 240 can be directly led out from the four corners of the base 10 without bending, which saves the materials of the movable contact leading-out pieces 240 and reduces the material cost.

It should be noted that since two movable contact pieces 210 in each contact part 20 are parallel to each other, and the two movable contact pieces 210 have an inner surface 2120 facing each other, the anti-short circuit function can be realized. Therefore, in the embodiment of the present disclosure, the current directions of the movable contact leading-out piece 240 and the movable contact piece 210 need not be disposed in opposite directions, that is, the movable contact leading-out piece 240 does not participate in the function of resisting the electric repulsion force between the contacts. In this way, four movable contact leading-out pieces 240 can be arranged at four corners of the base 10, and the distance between the four movable contact leading-out pieces 240 is increased, thus achieving the effect of reducing the temperature rise.

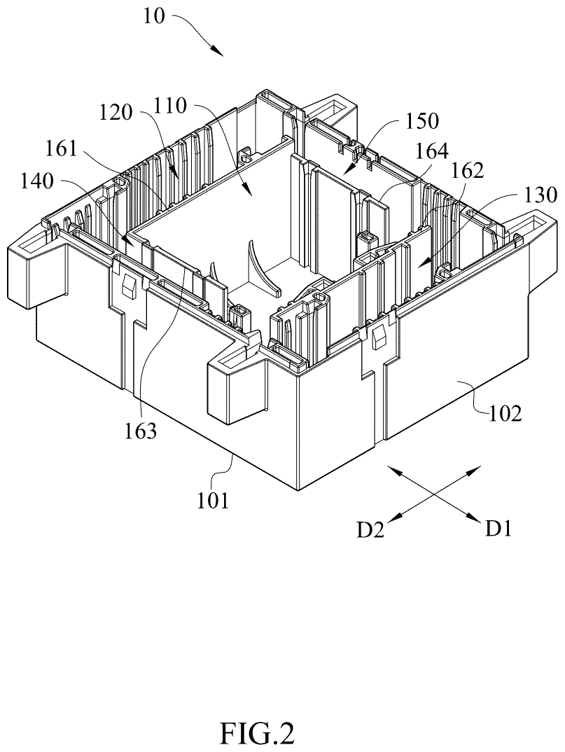

With continued reference to FIGS. 1 to 2, the base 10 includes a first partition 161 and a second partition 162, the first partition 161 is connected to the bottom plate 101 and between the first contact area 120 and the middle area 110. the second partition 162 is connected to the bottom plate 101 and between the second contact area 130 and the middle area 110. Through the design of the first partition 161 and the second partition 162, The first partition 161 separates one of the contact part 20 from the magnetic circuit part 30, The second partition 162 separates the other contact part 20 from the magnetic circuit part 30, so that the thermal radiation generated by one contact part 20 is blocked by the first partition 161. The thermal radiation generated by the other contact part 20 is blocked by the second partition 162, thus avoiding the mutual influence of the thermal radiation generated by the two contact parts 20.

With continued reference to FIGS. 1 to 2, the base 10 also has a first moving area 140 and a second moving area 150 spaced from each other along the second direction D2, and the middle area 110 is located between the first moving area 140 and the second moving area 150.

The push rod assembly 40 includes a first push rod 410 and a second push rod 420. The magnetic circuit part 30 is drivable connected with the first push rod 410 and the second push rod 420, respectively, so as to drive the movement of the first push rod 410 at the first moving area 140 and the movement of the second push rod 420 at the second moving area 150.

As shown in FIG. 3, one end of the first push rod 410 is connected to the first end 210a of one of the movable contact pieces 210 in the contact parts 20 disposed in the first contact area 120, and the other end of the first push rod 410 is connected to the first end 210a of the other of the movable contact pieces 210 in the contact parts 20 disposed in the second contact area 130. One end of the second push rod 420 is connected to the first end 210a of the other of the movable contact pieces 210 in the contact part 20 disposed in the first contact area 120, and the other end of the second push rod 420 is connected to the first end 210a of the other of the movable contact pieces 210 in the contact parts 20 disposed in the second contact area 130.

In this embodiment, the push rod assembly 40 adopts a dual push rod structure with the first push rod 410 and the second push rod 420, and the connecting or disconnecting of the contacts can be achieved through the push-pull movement of the dual push rod structure.

Specifically, the movement directions of the first push rod 410 and the second push rod 420 are opposite. If the first push rod 410 moves downwards, then the second push rod 420 moves upwards. Since the first push rod 410 moves downwards, the two movable contact pieces 210 connect to the first push rod 410, both pivots move downwards around their respective second ends 210b. Since the second push rod 420 moves upwards, the two movable contact pieces 210 connect to the second push rod 420, both pivots move upwards around their respective second ends 210b. In one contact part 20, the two movable contact pieces 210 pivot in opposite directions and move away from each other, thereby achieving the disconnection of the movable contact 221 and the static contact 231.

Conversely, if the first push rod 410 moves upwards, then the second push rod 420 moves downwards. The two movable contact pieces 210 connects to the first push rod 410, both pivots move upwards around their respective second ends 210b, and the two movable contact pieces 210 connect to the second push rod 420, both pivots move downwards around their respective second ends 210b. In one contact part 20, the two movable contact pieces 210 pivot in opposite directions and move towards each other, achieving the connection of the movable contact 221 and the static contact 231.

The base 10 further includes a third partition 163 and a fourth partition 164. the third partition 163 is connected to the bottom plate 101 and between the first moving area 140 and the middle area 110. the fourth partition 164 is connected to the bottom plate 101 between the second moving area 150 and the middle area 110.

As shown in FIGS. 1 and 2, the first contact area 120, the first moving area 140, the second contact area 130 and the second moving area 150 are connected end-to-end to form a rectangular structure. The magnetic circuit part 30 is located in the rectangular structure, two contact part 20 are located at two opposite sides of the rectangular structure, and the first push rod 410 and the second push rod 420 are located at the other two opposite sides of the rectangular structure.

In a pair of contact pars 20, four sets of movable contact 221 and the static contact 231 are located at four corners of the rectangular structure respectively. In this way, four sets of movable contact 221 and the static contact 231 are respectively arranged at four corners of the rectangular structure so as to widen the distance between the sets of movable contact 221 and the static contact 231, and effectively reduce the thermal radiation influence between two adjacent sets of movable contact 221 and the static contact 231.

As an example, four movable contact leading-out pieces 240 of a pair of the contact part 20 are respectively located at four corners of a rectangular structure.

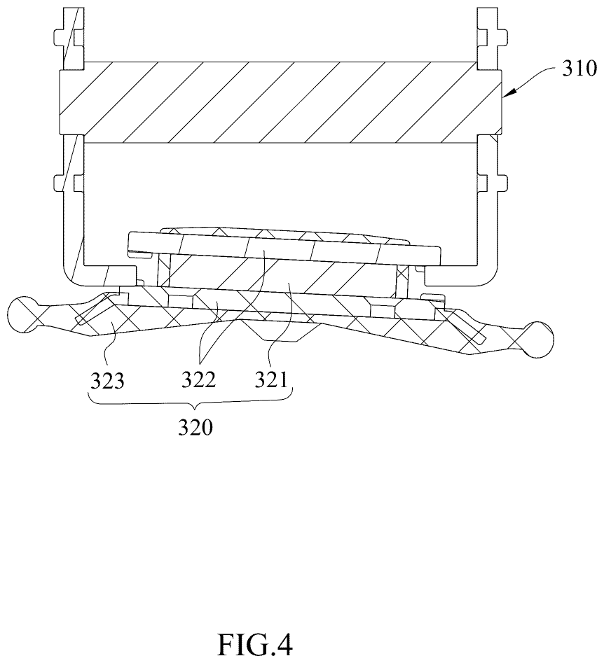

As shown in FIG. 4, the magnetic circuit part 30 includes a coil assembly 310 and an armature assembly 320, the armature assembly 320 is pivotally connected to the base 10 under the magnetic driving action of the coil assembly 310. The armature assembly 320 includes a permanent magnet 321, an armature 322, and a swinging arm 323. There are two armatures 322, and the permanent magnet 321 is clamped between the two armatures 322. The swinging arm 323 may be made of an insulating material, such as plastic. The permanent magnet 321, the armature 322, and the swinging arm 323 may be integrally connected by an injection molding. Two ends of the swinging arm 323 are respectively connected to the first push rod 410 and the second push rod 420.

By changing a direction of a magnetic field of the coil assembly 310 to drive the armature assembly 320 to pivot relative to the base 10. The swinging arm 323 of the armature assembly 320 respectively drive the reciprocated movement of the first push rod 410 and the second push rod 420 along the first direction D1, so as to achieve the connection or disconnection of the movable contact 221 and the static contact 231.

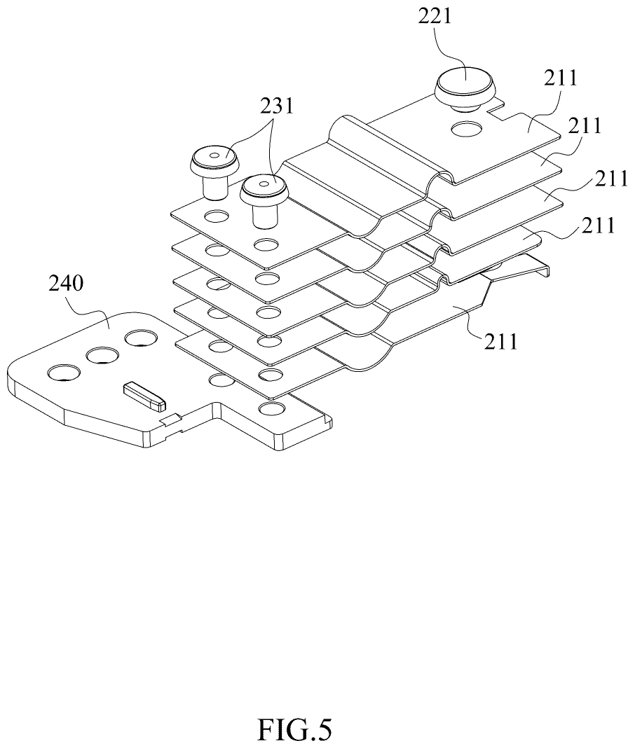

As shown in FIG. 5, the movable contact piece 210 of the movable contact part includes a plurality of sub-contact pieces 211 stacked with each other. In the embodiment of the present invention, the number of the sub-contact pieces 211 is five, but it is not limited to this. For example, the number of the sub-contact pieces 211 can also be two, three, four, six, etc. By designing the movable contact piece 210 to include a plurality of sub-contact pieces 211 stacked with each other, on the one hand, the thickness of the sub-contact pieces 211 is thin, and the movable contact piece 210 can be made of a thin strip material with lower material cost, which is convenient for operation; on the other hand, by increasing or decreasing the number of the sub-contact piece 211 according to the value of the current, the thickness of the movable contact piece 210 can be increased or decreased.

The movable contact 221 and the static contact 231 are both provided on the movable contact pieces 210. It can be understood that the movable contact 221 may be connected to the movable contact pieces 210 in an integral or separate manner, and the static contact 231 can also be connected to the movable contact pieces 210 in an integral or separate manner.

When the movable contact 221 and the static contact 231 are connected to the movable contact pieces 210 in the separate manner, the connection method may be riveting, but this is not limited thereto.

Of course, in other embodiments, the movable contact pieces 210 may also be an integral piece, without the multi-layer sub-contact pieces 211 stacked with each other.

It can be understood that the various examples/embodiments provided by the present disclosure can be combined with each other without contradiction, and detailed examples are not provided herein.

In addition, the movable contact piece in the relay is a component prone to temperature rise. In the prior art, in order to reduce the temperature rise of the relay, the movable contact piece with multiple contact sets is designed. However, the increase of the contact set will affect the control of contact parameters, increase the manufacturing difficulty and lead to low production efficiency.

The embodiment of the invention provides the contact part and the relay to solve the problems that the control of contact parameters is affected and the manufacturing is difficult in the prior art.

The embodiment of the present disclosure provides a contact part, which is applied to the relay. The contact part includes two sets of movable contact parts, each set of the movable contact part includes a movable contact piece, a movable contact unit and static contact unit, the movable contact unit is arrange on the movable contact piece, two movable contact units of the contact part correspond to the static contact unit; wherein the movable contact unit and the static contact unit in one set is defined as a first contact, the movable contact unit and the static contact unit in the other set is defined as a second contact;
the movable contact unit includes at least one movable contact, the static contact unit includes at least one static contact, the at least one movable contact corresponds to the at least one static contact, and the movable contact and the static contact corresponding with each other are formed a contact set, at least one of sets of the second contact and the first contact includes at least two contact sets.

According to some embodiments of the present disclosure, each set of the movable contact part further includes a movable contact leading-out piece connected to the movable contact piece, at least one static contact in the static contact unit is arranged on the movable contact piece and/or the movable contact leading-out piece.

According to some embodiments of the present disclosure, in each set of the movable contact part, at least one static contact in the static contact unit is arranged on a connection position of the movable contact piece and the movable contact leading-out piece.

According to some embodiments of the present disclosure, the movable contact piece has a first end and second end opposite to the fires tent in the length direction, at least one movable contact is arranged on the first end, and at least one static contact is arranged on the second end;
two movable contact pieces in the contact part are arranged parallel with each other, the movable contact unit on the first end of one of the movable contact pieces corresponds to the static contact unit on the second end of the other movable contact piece. So that two pairs of the movable contact unit contact with the static contact unit form a parallel circuit structure.

According to some embodiments of the present disclosure, wherein a number of the contact sets of the first contact is less than or equal to a number of the contact sets of the second contact.

According to some embodiments of the present disclosure, wherein the first contact includes one or two contact sets; and the second contact includes two or three contact sets.

According to some embodiments of the present disclosure, wherein the first contact includes two contact sets, and the two contact sets are arranged side by side in a width direction of the movable contact part;
the second contact includes two or three contact sets, and the two or three contact sets are arranged side by side in the width direction of the movable contact piece.

According to some embodiments of the present disclosure, wherein a slit is provided between the two movable contacts adjacent to each other on the movable contact piece in a width direction of the movable contact piece.

According to some embodiments of the present disclosure, wherein in a length direction of the movable contact piece, one end of the slit penetrates through an end face of the movable contact piece, and the other end of the slit extends to the static contact on the movable contact piece.

According to some embodiments of the present disclosure, the movable contact piece a plurality of the sub-contact piece stacked with each other.

A relay of present disclosure includes the contact part of present disclosure.

One embodiment in the above disclosure has at least the following advantages or beneficial effects:

At least one of the contact parts, the first contact and the second contact of the embodiment of the present disclosure includes at least two contact sets, so that the contact part includes at least three contact sets, thereby forming a multi-contact contact part. The parallel structure formed by at least three contact sets of the contact part can further reduce the temperature rise of the relay. At the same time, at least contact sets are not centrally arranged, but correspond to the first contact and the second contact respectively, so that the contact parameters of the respective contact sets in the first contact and the second contact are easy to control, and the manufacturing is simple, which is beneficial to improving the production efficiency.

Example embodiments will now be described more fully with reference to the accompanying drawings. Example embodiments may, however, be embodied in various forms and should not be construed as limited to the embodiments set forth herein; rather, these embodiments are provided so that this disclosure will be thorough and complete, and will fully convey the concepts of the example embodiments. To those skilled in the art. The same reference numerals in the drawings indicate the same or similar structures, and thus their detailed descriptions will be omitted.

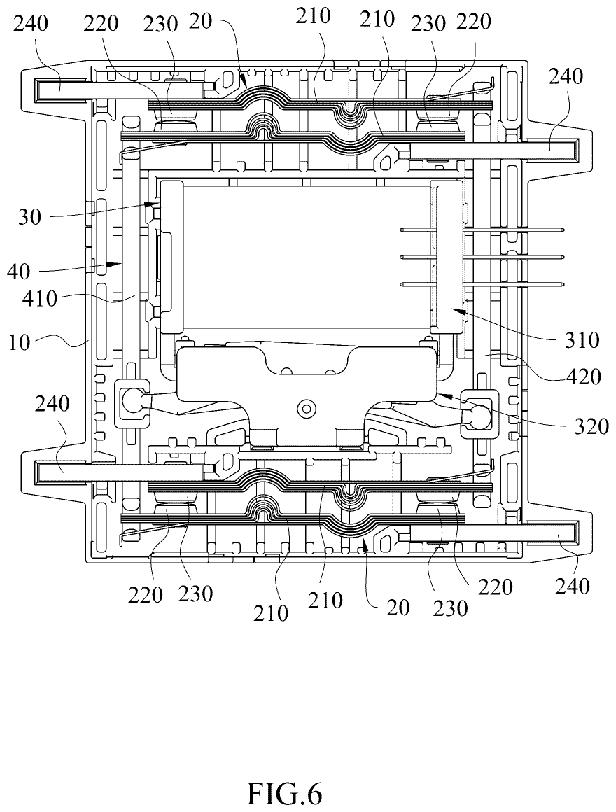

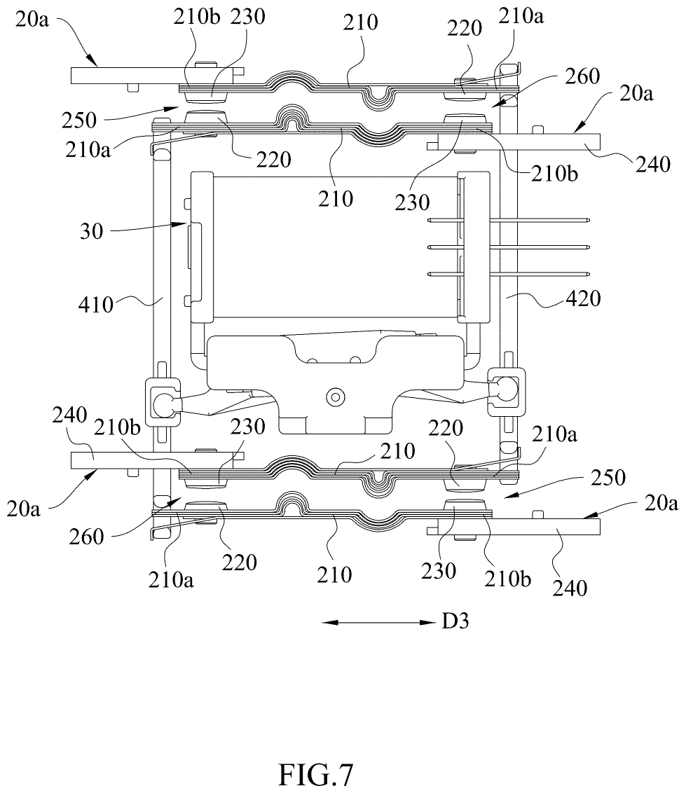

As shown in FIGS. 6 and 7, a relay according to the embodiments of the present disclosure includes a base 10, a pair of contact parts 20, a magnetic circuit part 30, and a push rod assembly 40. The pair of contact parts 20 and the magnetic circuit part 30 are disposed on the base 10 The magnetic circuit part 30 drives contacts of the pair of contact parts 20 to connect or disconnect through the push rod assembly 40.

It is understood that the terms “include” and “have” and their any variations used in the embodiments of the present disclosure are intended to cover non-exclusive inclusions. For example, a process, method, system, product, or apparatus that includes a series of steps or units is not limited to the listed steps or units, but may optionally include steps or units not listed, or may optionally include other inherent steps or components for these processes, methods, products, or apparatuses.

In one embodiment, the base 10 may be substantially cubic in shape, but is not limited thereto.

A pair of contact parts 20 may be respectively disposed on two opposite sides of the magnetic circuit part 30. Of course, the pair of the contact parts 20 may also be disposed on the same side of the magnetic circuit part 30.

Each contact part 20 includes two sets of movable contact parts 20a. Each set of movable contact parts 20a includes a movable contact piece 210, a movable contact unit 220, a static contact unit 230, and a movable contact leading-out piece 240. The movable contact piece 210 is connected to the movable contact leading-out piece 240. The movable contact unit 220 is disposed on the movable contact piece 210, and the static contact unit 230 is disposed on the movable contact piece 210 and/or the movable contact leading-out piece 240. Two movable contact units 220 of each contact part 20 correspond to two static contact units 230 of each contact part 20, respectively.

The magnetic circuit part 30 is disposed on the base 10 and is used to drive the movement of four movable contact pieces 210 of the pair of contact parts 20 through the push rod assembly 40, thereby connecting and disconnecting the movable contact units 220 and the static contact units 230.

It is understood that the relay of the embodiments of the present disclosure includes a pair of contact parts 20. Each contact part 20 can control one circuit, so that the relay of the embodiments of the present disclosure can control at least two circuits

Of course, in other embodiments, the relay may include only one contact part 20, which can control one circuit, thereby enabling the relay to control one circuit.

As an example, in each set of movable contact parts 20a, the static contact unit 230 is disposed at a connection position between the movable contact piece 210 and the movable contact leading-out piece 240.

As shown in FIG. 6 and FIG. 7, the movable contact piece 210 has the first end 210a and the second end 210b oppositely arranged in the length direction D3. As shown in FIGS. 6 and 7, which are oppositely arranged. The movable contact piece 210 has a first end 210a and a second end 210b opposite to each other along the length direction D3. That is to say, the first end 210a and the second end 210b are respectively arranged at two ends of the movable contact piece 210 in the length direction D3, so that a larger distance can be drawn between the first end 210a and the second end 210b. The movable contact unit 220 is disposed at the first end 210a, and the static contact unit 230 is disposed at the second end 210b. Moreover, the second end 210b of the movable contact piece 210 is connected to the movable contact leading-out piece 240, so that the static contact unit 230 is disposed at a connection position between the second end 210b of the movable contact piece 210 and the movable contact leading-out piece 240.

In the contact part 20, two movable contact pieces 210 are parallel with each other. The movable contact unit 220 at the first end 210a of one of the movable contact pieces 210 corresponds to the static contact unit 230 at the second end 210b of the other of the movable contact pieces 210, such that two pairs of the movable contact units 220 and the static contact units 230 after being connected form a circuit structure in parallel. The design of the contact part 20 as a parallel circuit structure can effectively reduce a temperature rise.

It can be understood that in the embodiment of the present disclosure, in one contact part 20, the movable contact unit 220 and the static contact unit 230 corresponding with each other in two sets are defined as a first contact 250 and a second contact 260 respectively. The first contact 250 and the second contact 260 are disposed in the first end 210a and the second end 210b of the movable contact piece 210, respectively. That is to say, in the length direction, one end of two parallel movable contact pieces 210 is provided with a one of the first contact 250 and the second contact 260, and the other end of the two parallel movable contact pieces 210 is provided with the other one of the first contact 250 and the second contact 260. In this way, the distance between the first contact 250 and the second contact 260 can be enlarged, the electric arc generated by the first contact 250 can be prevented from polluting the second contact 260, and the service life of the product can be prolonged.

As shown in FIGS. 6 and 7, the push rod assembly 40 includes a first push rod 410 and a second push rod 420, which are respectively disposed on the other two opposite sides of the magnetic circuit part 30. The magnetic circuit part 30 is drivable connected with the first push rod 410 and the second push rod 420, respectively, so as to drive the first push rod 410 and the second push rod 420 to reciprocate.

One end of the first push rod 410 is connected to the first end 210a of one of the movable contact pieces 210 in one of the contact parts 20, and the other end of the first push rod 410 is connected to the first end 210a of the other of the movable contact pieces 210 in the other of the contact parts 20. The one end of the second push rod 420 is connected to the first end 210a of the other of the movable contact pieces 210 in one of the contact parts 20, and the other end of the second push rod 420 is connected to the first end 210a of the other of the movable contact pieces 210 in the other of the contact parts 20.

In this embodiment, the push rod assembly 40 adopts a dual push rod structure with the first push rod 410 and the second push rod 420, and the connecting or disconnecting of the contacts can be achieved through the push-pull movement of the dual push rod structure.

Specifically, as shown in FIG. 7, the movement directions of the first push rod 410 and the second push rod 420 are opposite. If the first push rod 410 moves downwards, then the second push rod 420 moves upwards. Since the first push rod 410 moves downwards, the two movable contact pieces 210 connected to the first push rod 410 both pivot downwards around their respective second ends 210b. Since the second push rod 420 moves upwards, the two movable contact pieces 210 connected to the second push rod 420 both pivot upwards around their respective second ends 210b. In one contact part 20, the two movable contact pieces 210 pivot in opposite directions and move away from each other, thereby achieving the disconnection of the movable contact unit 220 and the static contact unit 230.

Conversely, if the first push rod 410 moves upwards, then the second push rod 420 moves downwards. The two movable contact pieces 210 connected to the first push rod 410 both pivot upwards around their respective second ends 210b, and the two movable contact pieces 210 connected to the second push rod 420 both pivot downwards around their respective second ends 210b. In one contact part 20, the two movable contact pieces 210 pivot in opposite directions and move towards each other, achieving the connection of the movable contact unit 220 and the static contact unit 230.

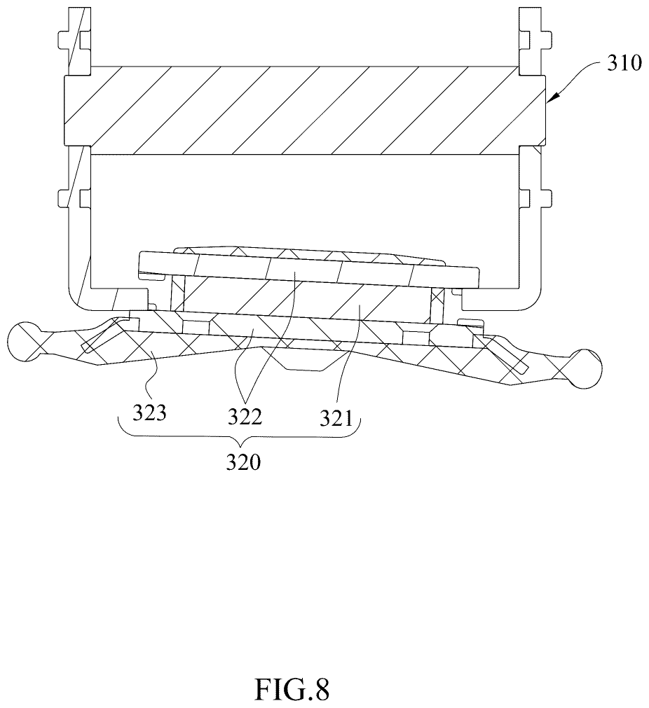

As shown in FIG. 8, the magnetic circuit part 30 includes a coil assembly 310 and an armature assembly 320, the armature assembly 320 is pivotally connected to the base 10 under the magnetic driving action of the coil assembly 310. The armature assembly 320 includes a permanent magnet 321, an armature 322, and a swinging arm 323. There are two armatures 322, and the permanent magnet 321 is clamped between the two armatures 322. The swinging arm 323 may be made of an insulating material, such as plastic. The permanent magnet 321, the armature 322, and the swinging arm 323 may be integrally connected by an injection molding. Two ends of the swinging arm 323 are respectively connected to the first push rod 410 and the second push rod 420.

By changing a direction of a magnetic field of the coil assembly 310 to drive the armature assembly 320 to pivot relative to the base 10. The swinging arm 323 of the armature assembly 320 respectively drive the reciprocated movement of the first push rod 410 and the second push rod 420, so as to achieve the connection or disconnection of the movable contact unit 220 and the static contact unit 230.

In one contact part 20, the movable contact unit 220 and the static contact unit 230 corresponding with each other in one set is defined as a first contact 250, and the movable contact unit 220 and the static contact unit 230 corresponding with each other in the other set is defined as a second contact 260. As shown in FIG. 7, in the contact part 20 located above the magnetic circuit part 30, the movable contact unit 220 and the static contact unit 230 on the left side are defined as the first contact 250, and the movable contact unit 220 and the static contact unit 230 on the right side are defined as the second contact 260; in the contact part 20 located below the magnetic circuit part 30, the movable contact unit 220 and the static contact unit 230 on the right side are defined as the first contact 250, and the movable contact unit 220 and the static contact unit 230 on the left side are defined as the second contact 260.

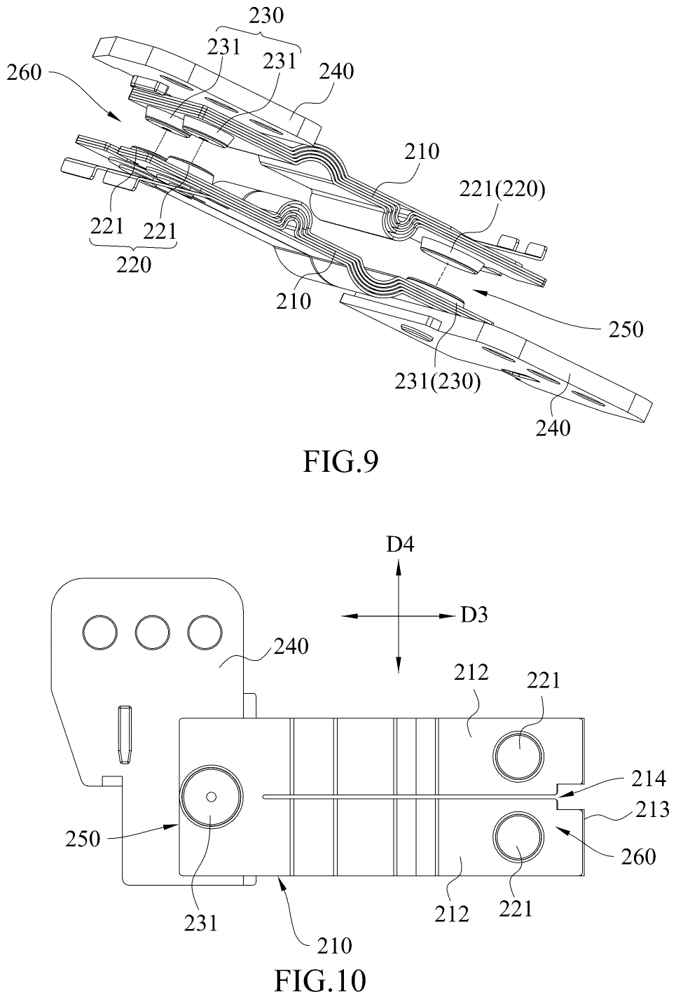

As shown in FIGS. 9 and 10, the movable contact unit 220 includes at least one movable contact 221, the static contact unit 230 includes at least one static contact 231, the movable contact 221 and the static contact 231 corresponding with each other forma a contact set, the first contact 250 includes at least one contact set, the second contact 260 includes at least one contact set. at least one of the second contact 260 and the first contact 250 includes at least two contact sets. Further, the number of the contact set of the first contact 250 is less than or equal to number of the contact set of the second contact 260.

In this embodiment, at least one of the first contact 250 and the second contact 260 includes at least two contact sets, so that the contact part 20 includes at least three contact sets, thereby forming a multi-contact contact part 20. The parallel structure formed by at least three contact sets of the contact part 20 can further reduce the temperature rise of the relay. At the same time, at least contact sets are not centrally arranged, but correspond to the first contact 250 and the second contact 260 respectively, so that the contact parameters of the respective contact sets in the first contact 250 and the second contact 260 are easy to control, and the manufacturing is simple, which is beneficial to improving the production efficiency.

In the embodiment of the present disclosure, in the length direction D3, a part of at least three contact sets is arranged at one end of two parallel movable contact pieces 210, and the other part of at least three contact sets is arranged at the other end of two parallel movable contact pieces 210.

As shown in FIGS. 9 and 10, in the embodiments of the present disclosure, the contact part 20 includes three sets of contact sets, among which the number of contact sets of the first contact 250 is 1, and the number of contact sets of the second contact 260 is 2. The two contact sets of the second contact 260 are arranged side by side along a width direction D4 of the movable contact piece 210.

Please continue to refer to FIG. 10, along the width direction D4 of the movable contact piece 210, a slit 214 is provided between the two movable contacts 221 adjacent to each other on the movable contact piece 210. Furthermore, along a length direction D3 of the movable contact piece 210, one end of the slit 214 penetrates through an end face 213 of the movable contact piece 210, and the other end of the slit 214 extends to the static contact 231 on the movable contact piece 210.

In this embodiment, by providing a slit 214 on the movable contact piece 210, the movable contact piece 210 is divided into a plurality of current carriers 212 by the slit 214. The movable contacts 221 on the movable contact piece 210 are provided correspondingly on the plurality of current carriers 212. Thus, the movable contacts 221 on the movable contact piece 210 can move relatively independently, enabling the movable contacts 221 to reliably contact the static contact 231, avoiding a situation where some of the movable contacts 221 on the movable contact piece 210 have already contacted the static contact 231, while the other movable contacts 221 have not yet contacted the static contact 231, thereby improving contact reliability of the contacts.

Of course, in other embodiments, a slit 214 may not be provided on the movable contact piece 210.

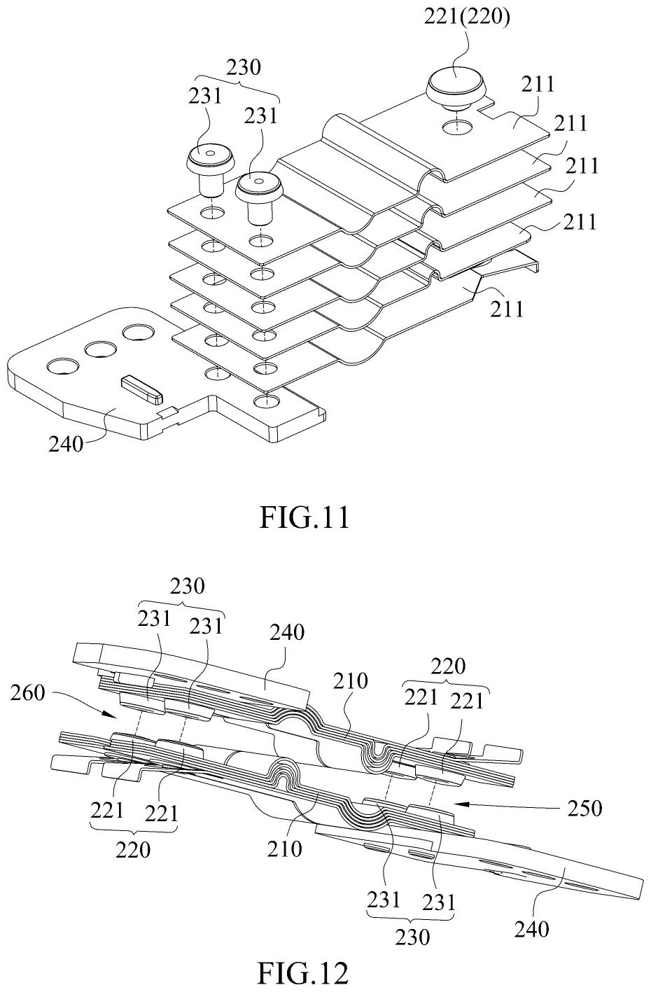

As shown in FIG. 11, the movable contact piece 210 of the movable contact part includes a plurality of sub-contact pieces 211 stacked with each other. In the embodiment of the present invention, the number of the sub-contact pieces 211 is five, but it is not limited to this. For example, the number of the sub-contact pieces 211 can also be two, three, four, six, etc. By designing the movable contact piece 210 to include a plurality of sub-contact pieces 211 stacked with each other, on the one hand, the thickness of the sub-contact pieces 211 is thin, and the movable contact piece 210 can be made of a thin strip material with lower material cost, which is convenient for operation; on the other hand, by increasing or decreasing the number of the sub-contact piece 211 according to the value of the current, the thickness of the movable contact piece 210 can be increased or decreased.

The movable contact 221 and the static contact 231 are both provided on the movable contact pieces 210. It can be understood that the movable contact 221 may be connected to the movable contact pieces 210 in an integral or separate manner, and the static contact 231 can also be connected to the movable contact pieces 210 in an integral or separate manner.

When the movable contact 221 and the static contact 231 are connected to the movable contact pieces 210 in the separate manner, the connection method may be riveting, but this is not limited thereto.

Of course, in other embodiments, the movable contact pieces 210 may also be an integral piece, without the multi-layer sub-contact pieces 211 stacked with each other.

For the first contact, since the number of contact set is small, the volume of each contact can be designed to be larger, which improves the durability of the contact. Moreover, the first contact has fewer contact sets, which is convenient for measuring contact parameters. For the second contact, there are more contact sets, forming a multi-contact parallel structure, thereby reducing the temperature rise.

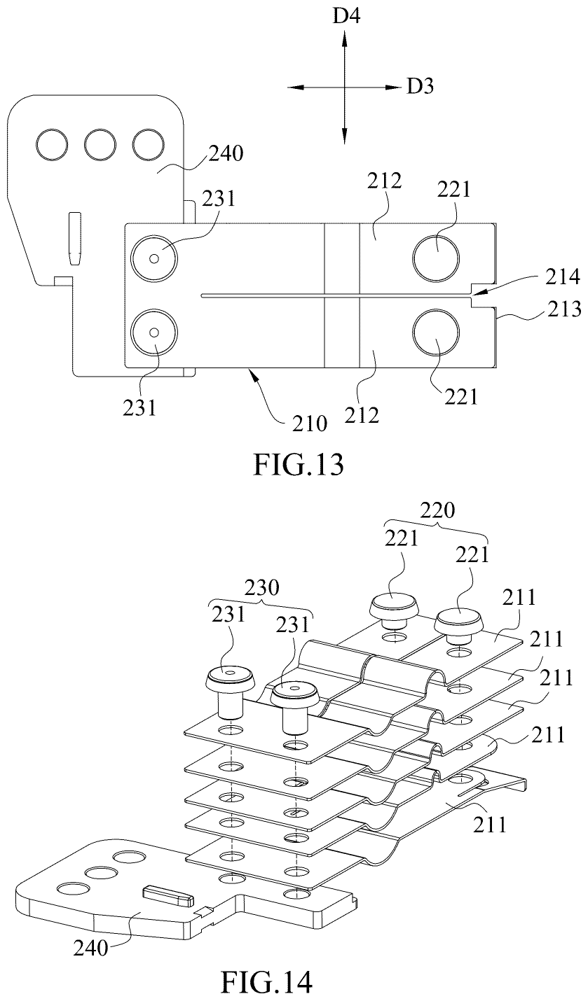

As shown in FIGS. 12 to 14, compared to the contact part 20 of the first embodiment, the contact part 20 of the second embodiment has a substantially similar structure in the basic configuration. Therefore, in the following description of the contact part 20 of the second embodiment, the structures already described in the first embodiment will not be repeated. In addition, the structures in the contact part 20 of the second embodiment that are the same as those described in the first embodiment will be denoted by the same reference numerals. Therefore, in the following description of the present embodiment, the differences between the contact part 20 of the second embodiment and the contact part 20 of the first embodiment will be mainly described.

In this embodiment, the contact part 20 includes four sets of contacts, among which the number of contact sets of the first contact 250 is 2, and the number of contact sets of the second contact 260 is 2. The two contact sets of the first contact 250 and the two contact sets of the second contact 260 are respectively arranged along the width direction D4 of the movable contact piece 210.

The movable contact piece 210 may be provided with a slit 214, or not.

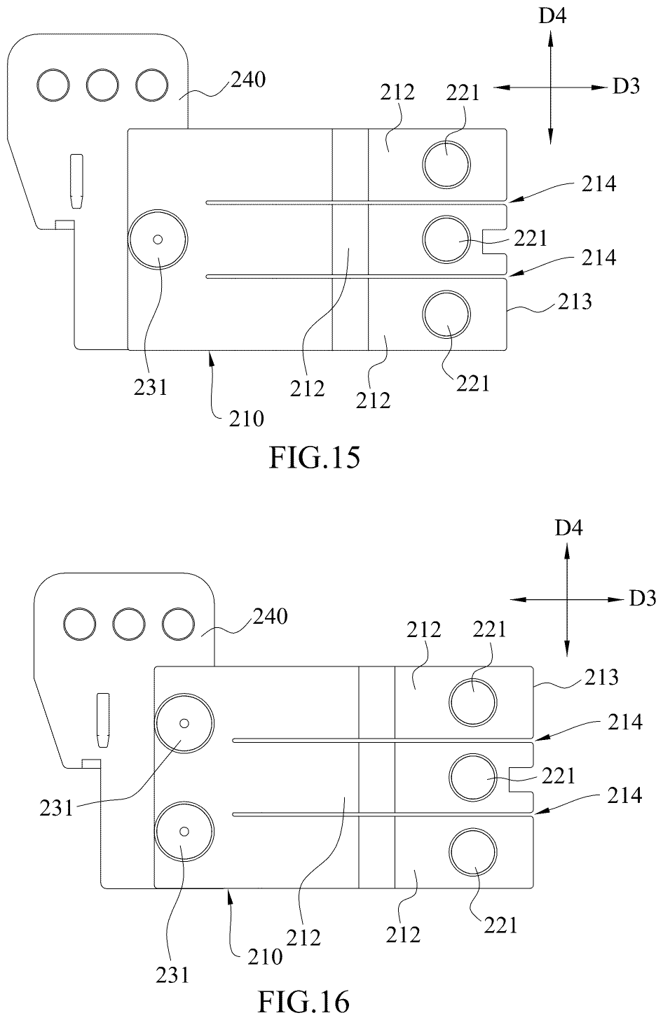

As shown in FIG. 15, compared to the contact part 20 of the second embodiment, the contact part 20 of the third embodiment has a substantially similar structure in its basic configuration. Therefore, in the following description of the contact part 20 of the third embodiment, the structures already described in the second embodiment will not be repeated. In addition, the structures in the contact part 20 of the third embodiment that are the same as those described in the second embodiment will be denoted by the same reference numerals. Therefore, in the following description of the present embodiment, the differences between the contact part 20 of the third embodiment and the contact part 20 of the second embodiment will be mainly described.

In this embodiment, the contact part 20 includes four sets of contact sets, among which the number of contact sets of the first contact 250 is 1, and the number of contact sets of the second contact 260 is 3. Among the second contact 260, three sets of contact sets are arranged side by side along the width direction D4 of the movable contact piece 210.

The movable contact piece 210 may be provided with a slit 214, or not.

As shown in FIG. 16, compared to the contact part 20 of the first embodiment, the contact part 20 of the fourth embodiment has a substantially similar structure in its basic configuration. Therefore, in the following description of the contact part 20 of the fourth embodiment, the structures already described in the first embodiment will not be repeated. In addition, the structures in the contact part 20 of the fourth embodiment that are the same as those described in the first embodiment will be denoted by the same reference numerals. Therefore, in the following description of the present embodiment, the differences between the contact part 20 of the fourth embodiment and the contact part 20 of the first embodiment will be mainly described.

In this embodiment, the contact part 20 includes five sets of contact sets, among which the number of contact sets of the first contact 250 is 2, and the number of contact sets of the second contact 260 is 3.

In the first contact 250, two sets of contacts are arranged side by side along the width direction D2 of the movable contact piece 210. In the second contact 260, three sets of contacts are arranged side by side along the width direction D4 of the movable contact piece 210.

It can be understood that the various embodiments/implementations provided by the present disclosure can be combined with each other without causing conflicts, and examples will not be given one by one here.

In the embodiment of the present disclosure, the terms “first”, “second” and “third” are only used for description purposes and cannot be understood as indicating or implying relative importance; the term “plurality” refers to two or Two or more, unless otherwise expressly limited. The terms “installation”, “connection”, “connection” and “fixing” should be understood in a broad sense. For example, “connection” can be a fixed connection, a detachable connection, or an integral connection; “connection” can be Either directly or indirectly through an intermediary. For those of ordinary skill in the art, the specific meanings of the above terms in the embodiments of the present disclosure can be understood according to specific circumstances.

In the description of the embodiments of the present disclosure, it should be understood that the directions or positional relationships indicated by the terms “upper”, “lower”, “left”, “right”, “front”, “back”, etc. are based on those shown in the accompanying drawings. The orientation or positional relationship is only for the convenience of describing the embodiments of the present disclosure and simplifying the description. It does not indicate or imply that the device or unit referred to must have a specific direction, be constructed and operated in a specific orientation, and therefore, it cannot be understood as a limitation of the present disclosure. Limitations of Disclosure Embodiments.

In the description of this specification, the terms “one embodiment,” “some embodiments,” “specific embodiments,” etc., mean that a particular feature, structure, material or characteristic described in connection with the embodiment or example is included in the disclosure. In at least one embodiment or example of an embodiment. In this specification, schematic representations of the above terms do not necessarily refer to the same embodiment or example. Furthermore, the specific features, structures, materials or characteristics described may be combined in any suitable manner in any one or more embodiments or examples.

The above are only preferred embodiments of the present disclosure, and are not intended to limit the embodiments of the present disclosure. For those skilled in the art, various modifications and changes may be made to the embodiments of the present disclosure. Any modifications, equivalent substitutions, improvements, etc. made within the spirit and principles of the embodiments of the present disclosure shall be included in the protection scope of the embodiments of the present disclosure.

What is claimed is:

1. A relay, comprising:
a base having a middle area, a first contact area and a second contact area, the middle area is arranged between the first contact area and the second contact area, the first contact area and the second contact area are arranged spaced with each other along the first direction;
a pair of contact parts respectively arranged in the first contact area and the second contact area; each contact part comprising two sets of the movable contact part, each set of the movable contact part comprising a movable contact piece, a movable contact and a static contact, the movable contact piece having a first end and a second end in a second direction, the movable contact being provided on the first end and the static contact being provided on the second end; two movable contacts corresponding to two static contacts respectively in each contact part; wherein the second direction is perpendicular to the first direction; and
a magnetic circuit part arranged on the middle area of the base, and configured to drive four movable contact pieces of the pair of contact parts through a push rod assembly to move, thereby realizing connection or disconnection of the movable contact and the static contact.

2. The relay according to claim 1, wherein each set of movable contact part further comprises a movable contact leading-out piece connected to the movable contact piece.

3. The relay according to claim 2, wherein four movable contact leading-out pieces in a pair of contact part are located at four corners of the base respectively.

4. The relay according to claim 2, wherein in each set of the movable contact part, the static contact is located at a connection position of the second end and the movable contact leading-out piece of the movable contact piece.

5. The relay according to claim 1, wherein a length of the movable contact piece extends along the second direction.

6. The relay according to claim 1, wherein the base comprises:
a first partition, arranged between the first contact area and the middle area;
a second partition, arranged between the second contact area and the middle area.

7. The relay according to claim 1, wherein the base further has a first moving area and a second moving area spaced from each other along the second direction, and the middle area is located between the first moving area and the second moving area;
the push rod assembly comprises a first push rod and a second push rod, the magnetic circuit part respectively drivably connected to the first push rod and the second push rod, so that the first push rod movably arranged in the first moving area, and the second push rod movably arranged in the second moving area;
one end of the first push rod is connected to the first end of one of the movable contact pieces of the contact part in the first contact area, the other end of the first push rod is connected to the first end of one of the movable contact pieces of the contact part in the second contact area;
one end of the second push rod is connected to the first end of one of the other movable contact pieces of the contact part in the first contact area, the other end of the second push rod is connected to the first end of the other movable contact piece of the contact part in the second contact area.

8. The relay according to claim 7, wherein the magnetic circuit part comprises a coil assembly and an armature assembly, the armature assembly is pivotally connected to the base under a magnetic driving action of the coil assembly;
the armature assembly is respectively connected to the first push rod and the second push rod and configured to drive the first push rod and the second push rod to reciprocate in the first direction.

9. The relay according to claim 8, wherein the first push rod and the second push rod move in opposite directions.

10. The relay according to claim 7, wherein the first contact area, the first moving area, the second contact area and the second moving area are sequentially connected end-to-end to form a rectangular structure.

11. The relay according to claim 10, wherein in a pair of contact part, four sets of the movable contact and the static contact are located at four corners of the rectangular structure respectively.

12. The relay according to claim 10, wherein each set of the movable contact part further comprises a movable contact leading-out piece connected to the movable contact piece, the static contact is arranged on the movable contact piece and/or the movable contact leading-out piece;
four movable contact leading-out pieces in a pair of contact part are located at four corners of the rectangular structure respectively.

13. The relay according to claim 7, wherein the base further comprises:
a third partition, arranged between the first moving area and the middle area;
a fourth partition, arranged between the second moving area and the middle area.

14. The relay according to claim 1, wherein the movable contact piece comprises a plurality of sub-contact pieces stacked with each other.

15. The relay according to claim 1, wherein two movable contact pieces in the contact part are parallel with each other, and the two movable contact pieces have inner surfaces facing each other.

16. The relay according to claim 1, wherein a length direction and the second direction of the movable contact piece are parallel with each other;
opposite ends of the movable contact piece in the length direction are respectively provided with the first end and the second end.
